(19) United States
(12) Patent Application Publication
(10) Pub. No.: US 2006/0246199 A1
(43) Pub. Date: Nov. 2, 2006

(54) Low-carbohydrate food product and method of manufacturing

(76) Inventor: Robert Fletcher, Hoskins, NE (US)

Correspondence Address: Hovey Williams LLP, 2405 Grand Blvd., Suite 400, Kansas City, MO, 64108, US

(21) Appl. No.: 11/116,711

(22) Filed: Apr. 28, 2005

(51) Int. Cl. A23C 19/00

(52) U.S. Cl. 426/582

(57) ABSTRACT

A cheese product that is low in carbohydrates, fat, and cholesterol is manufactured by placing a quantity of pre-cooked cheese on an infeed portion of a twin-belt grill, cooked by conveying the cheese through a cooking portion of the grill wherein the cheese is contacted by upper and lower cooking surfaces, and allowed to cool on a discharge portion of the grill. The cooked cheese is cut into pieces and packaged for distribution, and may be stored on a shelf without refrigeration.

### BACKGROUND OF THE INVENTION

1. Field of the Invention

The present invention relates to food products that are low in carbohydrates. More particularly, the present invention involves a method of making a cheese product, wherein the method is substantially automated and the cheese product is low in carbohydrates, fat and cholesterol and may be stored at room temperature.

2. Description of Prior Art

Many people seek to maintain healthy diets by following the guidelines of one or more diet plans. Such diet plans have traditionally required moderation in the consumption of foods that are high in fats, sugars, and cholesterol. Furthermore, in recent years diet plans such as the ATKINS™ diet and the SOUTH BEACH™ diet encourage limited consumption of foods that are high in carbohydrates. Unfortunately, the requirements of these and other diet plans are often at odds with the lifestyles of those who seek to follow the plans. Snack foods and fast foods are popular with many people, for example, who maintain fast-paced lifestyles with little or no time to cook or sit down and eat a meal in the traditional sense. For those people, following a diet plan can be particularly difficult because snack foods and fast foods often rely on carbohydrates, fat and/or sugar to offer an appealing taste and a lengthy shelf life.

Some snack foods, such as some meat products and cheese products, conform to the requirements of one or more of the diet plans but suffer from other limitations. Diary products, for example, must be refrigerated before and/or after being removed from a package and therefore are not convenient to store on a shelf and/or carry for all or part of a day. Furthermore, many traditionally popular varieties of foods require the use of ingredients that are high in fat, cholesterol, and/or carbohydrates. Pizza, for example, is still an immensely popular food in the United States and is typically sold with bread crusts that are high in carbohydrates.

Therefore, there exists a need for a nutritional food product that is low in fat, cholesterol, and carbohydrates with an appealing taste for use as a snack food and as a substitute for less healthy ingredients in traditional foods.

### SUMMARY OF THE INVENTION

The present invention overcomes the above-described problems and limitations and provides a distinct advance in the art of food processing and manufacturing. More particularly, the present invention provides a method of manufacturing a cheese product that is low in carbohydrates, fat, and cholesterol and that has a substantial shelf-life at room temperature.

In a first embodiment, the invention involves a method of manufacturing a low-carbohydrate food product comprising the steps of placing a quantity of cheese between a first surface and a second surface so that the cheese is in contact with at least one of the surfaces, heating at least one of the surfaces to cook the cheese, and causing at least one of the surfaces to move so that the cheese is moved from a first location to a second location while it is being cooked.

In another embodiment, the quantity of cheese is automatedly placed between a first surface and a second surface so that the cheese is in contact with both of the surfaces, and both surfaces are heated to a temperature within the range 300 degrees Fahrenheit to 380 degrees Fahrenheit to cook the cheese. Both surfaces are also moved to transport the cheese from a first location to a second location while the cheese is being cooked. The cheese is then allowed to cool and is automatedly cut into pieces for packaging.

In yet another embodiment, the cheese is first prepared by reducing it to fine pieces and automatedly placing the pieces of cheese on a first end of a lower belt of a twin-belt grill, wherein the cheese is spread into a layer approximately three-eighths of an inch thick. An upper belt of the twin-belt grill is positioned so that a lower surface of the upper belt is spaced between one-fourth and one-half inch above an upper surface of the lower belt, and a plurality of platens on the grill are heated to transfer heat to the upper belt and to the lower belt of the grill, wherein the belts are heated to a temperature within the range 300 degrees Fahrenheit to 380 degrees Fahrenheit.

The belts are rotated to move the cheese between the belts toward a second end of the lower belt, wherein the cheese simultaneously contacts the lower belt and the upper belt for a period of between two and five minutes to cook the cheese. The cheese is then automatedly removed from the lower belt and allowed to cool for between eight and ten seconds. Finally, the cheese is die-cut for distribution.

These and other important features of the present invention are more fully described in the section titled DETAILED DESCRIPTION OF PREFERRED EMBODIMENTS, below.

### BRIEF DESCRIPTION OF THE DRAWINGS

A preferred embodiment of the present invention is described in detail below with reference to the attached drawing figures, wherein:

FIG. 1 is a perspective view of a twin-belt grill employed in a method of making a low-carbohydrate food product of the present invention;

FIG. 2 is a fragmented perspective view of the grill of FIG. 1, illustrating a pre-cooked quantity of cheese being delivered to a first end of the grill by an infeed conveyor;

FIG. 3 is a perspective view of the grill of FIG. 1, illustrating the quantity of cheese being cooked between upper and lower belts of the grill;

FIG. 4 is a fragmented perspective view of the grill of FIG. 1, illustrating a cooked cheese product being removed from the grill by an outfeed conveyor; and

FIG. 5 is a flowchart of steps involved in a process of the present invention for making a low-carbohydrate food product.

### DETAILED DESCRIPTION OF PREFERRED EMBODIMENTS

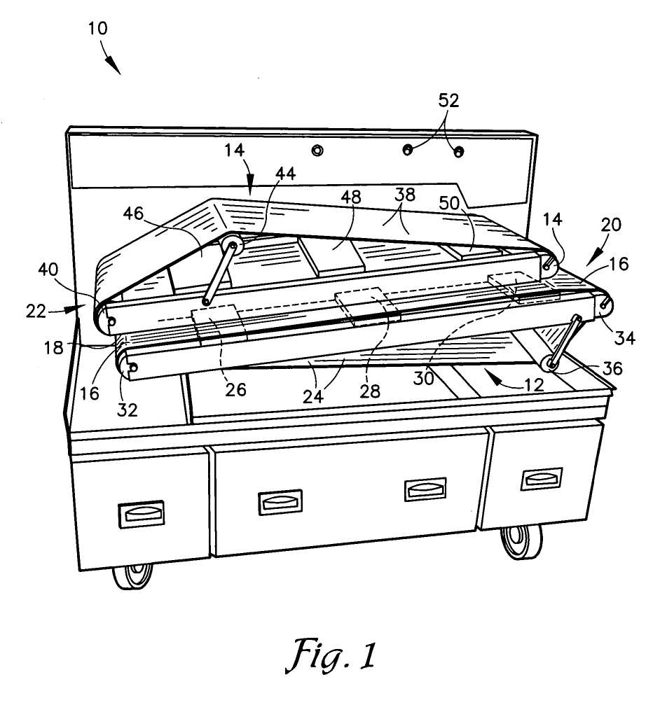

Referring initially to FIG. 1, an exemplary twin-belt grill employed in a method of the present invention is shown and designated generally by the reference numeral 10. The twin-belt grill 10 generally provides two opposing cooking surfaces operable to cook food in a continuous process. Particularly, the grill 10 provides a lower belt assembly 12 and an upper belt assembly 14, wherein the lower belt assembly 12 provides a lower cooking surface 16 and the upper assembly 14 provides an upper cooking surface 18, wherein the surfaces 16,18 are operable to cooperatively move food from a first end 20 of the grill 10 to a second end 22 of the grill 10 while simultaneously cooking the food.

The lower cooking surface 16 of the lower belt assembly 12 is generally a substantially flat, moveable heated surface for supporting and cooking the food product, as well as for conveying the food product from the first end 20 of the grill 10 to the second end 22 of the grill 10. The illustrated lower belt assembly 12 provides a belt 24 supported and heated by a plurality of platens 26,28,30 and entraining a plurality of rollers 32,34,36, wherein one or more of the rollers 32,34,36 drive the belt 24 in a rotational motion and are positioned to induce tension in the belt 24. Thus, the first cooking surface 16 is a surface of the belt 24 that faces away from the platens 26,28,30 and the rollers 32,34,36. The first cooking surface 16 preferably presents a non-stick coating, such as a TEFLON™ coating.

The platens 26,28,30 generally support and heat the belt 24. The illustrated platens 26,28,30 are rectangular in shape and each provide a smooth, flat surface that supports the belt 24 between the end rollers 32,34. The platens 26,28,30 are heated by electricity or other means, wherein the heat is transferred to the belt 24 when the belt 24 contacts the platens 26,28,30. The temperature of the platens 26,28,30 is user controlled and therefore can be changed to adjust the cooking temperature of the cooking surface 16 of the belt 24.

The upper belt assembly 14 is similar in form and function to the lower belt assembly 12, except that the upper cooking surface 18 of the upper belt assembly 14 cooks the food product opposite the first cooking surface 16 of the lower belt assembly 12. Thus, the upper belt assembly 14 and the lower belt assembly 12 cooperate to cook opposing sides of the food product. The illustrated upper belt assembly 14 provides a belt 38 driven by a plurality of rollers 40,42,44. In a manner similar to that of the lower belt assembly 12, the belt 38 of the upper assembly 14 is heated by a plurality of platens 46,48,50 and presents an outer non-stick surface 18. The lower belt 24 rolls in a direction opposite that of the upper belt 38 so that the cooking surfaces 16,18 of each belt 24,38 that contacts the food product is moving in the same direction—from the first end 20 of the grill 10 toward the second end 22 of the grill 10.

The upper belt assembly 14 and the lower belt assembly 12 have been described such that the lower cooking surface 16 and the upper cooking surface 18 both contact and cook the food as it passes through the grill 10. The method of the present invention is not so limited, however, and contemplates variations on the implementation described above. The grill 10 may function, for example, such that the food contacts only one of the cooking surfaces 16,18. In the latter scenario, the food may contact only the lower cooking surface 16 while being substantially close to the upper cooking surface 18 such that heat generated by the upper cooking surface 18 is transferred to the food. It will be appreciated that in such a scenario, the upper cooking surface 18 need not be moved to convey the food from the first end 20 to the second end 22 of the grill 10.

The twin-belt grill 10 is distinguished from traditional, batch-type convection ovens in several regards. First, the twin-belt grill 10 obviates the need for convection heating elements, which can be inefficient, in favor of the direct heating method wherein heat is transferred directly from the platens to the belts to the food, as explained above. Furthermore, the twin-belt grill 10 can be operated in a continuous process, with food product continuously being fed into the grill at the first end 20 and removed from the grill 10 at the second end 22. Further yet, the cooking temperature of the lower belt 24 and the cooking temperature of the upper belt 38 are independently controlled, such that each belt 24,38 may be set to a different cooking temperature. Distinct cooking temperatures may be desirable, for example, where a first side of the food product is in contact with the lower belt 24 longer than a second side of the food product is in contact with the upper belt 38.

In use, a user sets a cooking temperature of the lower belt 24 and a cooking temperature of the upper belt 38 via a manual control interface 52. As mentioned above, the user may desire to vary the temperature of the upper belt 38 relative to the temperature of the lower belt 24. The user also sets a distance of separation between the lower cooking surface 16 and the upper cooking surface 18 by adjusting a position of the upper belt assembly 12. The preferred distance of separation between the lower cooking surface 16 and the upper cooking surface 18 may be, for example, approximately one-half of the thickness of a food product placed on the lower belt 24. Finally, the user sets a speed at which the belts 24,38 are driven to determine a cooking time of the food product. A faster belt speed will move the food product through the grill 10 more quickly and therefore reduce the time the food is in contact with the belts 24,38, while a slower belt speed will increase the time the food product is in contact with the belts 24,38.

With the temperature, spacing, and heat set for a particular process, a food product is placed on the lower belt 24 at the first end 20 of the grill 10. In an automated process, the food is mechanically placed on the infeed portion 54 by, for example, a conveyor belt, a robotic arm, or other food dispenser. As the lower belt 24 rotates, it conveys the food product from the first end 20, through the grill 10, and toward the second end 22. As the food enters the grill 10, the upper belt 38 contacts the food product so that the food product is simultaneously cooked by the upper and the lower belts 38,24. When the food product emerges from the grill 10 at the second end 22, the food product is cooked and of substantially uniform thickness. The food product may then be removed from the lower belt 24 and cut into pieces for packaging.

It will be appreciated that the process described above may be performed continuously by continuously placing a food product on the lower belt 24 at the first end 20 of the grill 10 and continuously removing cooked food from the second end 22 the grill 10. It is not necessary, therefore, to stop the rotation of the belts 24,38 each time food is placed on the infeed portion 54 or removed from the discharge portion 58 of the grill 10. The continuous nature of the cooking process using the twin-belt grill 10 is advantageous in that the food is cooked more quickly and efficiently without the need to manually place the food in, or remove the food from, a conventional batch-type oven.

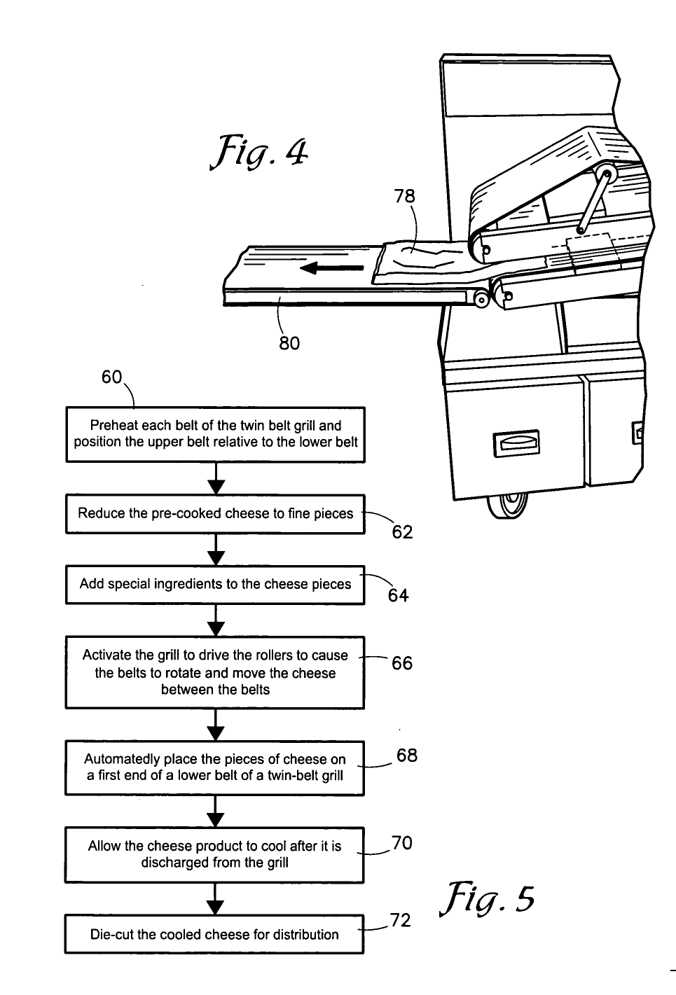

Referring also to FIG. 4, a flowchart of steps involved in an exemplary method of manufacturing a low-carbohydrate food product employing the principles of the present invention is shown. More particularly, the method involves using the twin-belt grill 10 to prepare a healthy snack food, pizza crust, food wrap, or other food product from cheese. The resulting product has the nutritional benefits of cheese with substantially less fat and cholesterol than the pre-cooked cheese, has no carbohydrate content, and has a substantial shelf life at room temperature.

The process is begun by preheating the lower belt 24 and the upper belt 38 via the platens 26,28,30,40,42,44 and positioning the upper belt 38 relative to the lower belt 24, as depicted in block 60. Both belts 24,38 are preferably heated to a temperature of 350 degrees Fahrenheit, although different temperatures may be used for different processes, and each belt 24,38 may be heated to a different temperature. Furthermore, the upper belt assembly 14 is preferably positioned so that there is between one-fourth and one-half inch of space between the lower cooking surface 16 and the upper cooking surface 18. This distance of separation between the lower cooking surface 16 and the upper cooking surface 18 is preferably approximately one-half the thickness of the layer of pre-cooked cheese placed on the lower belt 24.

The pre-cooked cheese 74 is prepared by reducing it to substantially fine pieces before placing it on the lower belt 24 at the infeed portion 54 of the grill 10, as depicted in block 62. The cheese may be shredded, for example, or ground into small chunks or a powder. While reducing the cheese to substantially fine pieces in this manner makes it easier to spread the cheese on the lower belt 24 of the grill to form a substantially uniform layer, it will be appreciated that the cheese 74 may be reduced to substantially course pieces or pieces of various sizes or, alternatively, may not be reduced or otherwise altered.

An exemplary process of making the pre-cooked cheese 74 is described below. The process of the present invention is not limited to use with a particular type of cheese, but is useful with various types of cheese products and blends of cheeses, although all-natural cheeses (without preservatives) are preferred. For example, the preferred cheese 74 (described below) may be supplemented with Parmesan cheese, Cheddar cheese, Monterey Jack cheese, or any combination thereof. Cheeses that have lower pre-cooked moisture content, such as Sharp Cheddar, are easier to crumble or otherwise reduce to small pieces, which facilitates the process of preparing the cheese 74 to be placed in the twin-belt grill 10.

Spices or other ingredients may be added to the pre-cooked cheese to impart a special flavor, or other characteristic such as color, to the resulting cheese product, as depicted in block 64. Caraway seeds, for example, may be added to the pre-cooked cheese, wherein a rate of 1-4% is preferred. Roasted garlic may also be added at the preferred rate of 1-2%. Cool ranch seasoning may be added at a preferred rate of 0.5-1.5%. Dried Cranberries at 1-2%; Apricots at 1-2%; shredded coconut at 1%. Finally, spices, coatings, or other finishing ingredients may be added to the resulting cheese product. It may be desirable, for example, to add butter to a product that will be used as pizza crust to add flavor.

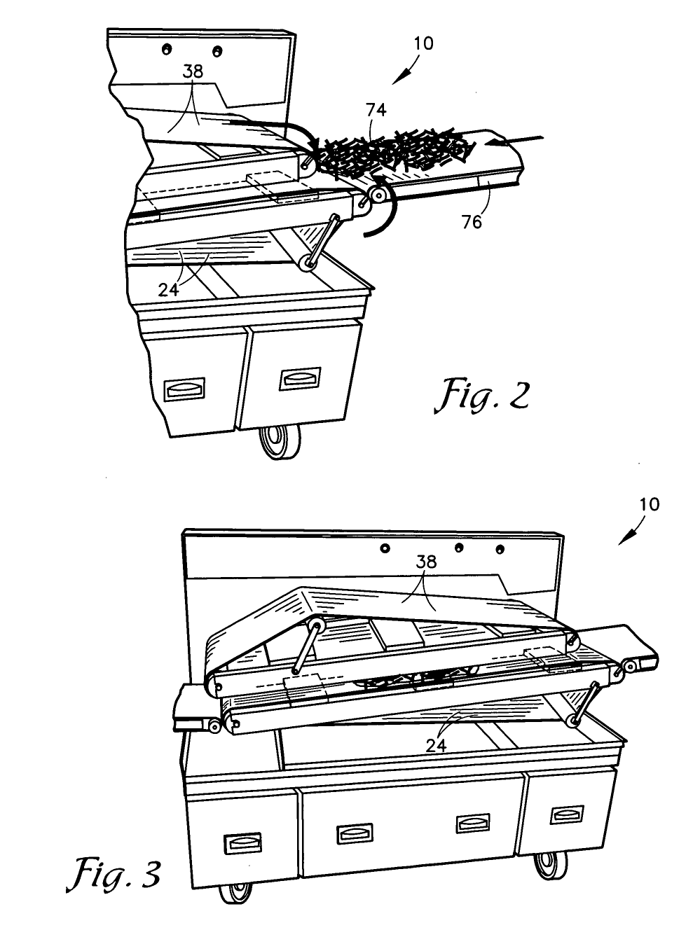

Once the grill 10 has been heated and positioned, and the pre-cooked cheese 74 has been prepared, the grill 10 is activated, as depicted in block 66, so that the drive rollers 32,40 cause the belts 24,38 to rotate. Once the belts 24,38 of the grill 10 are in motion, the pre-cooked cheese is automatedly placed on the lower belt 24 at the first end 20 of the grill 10, as depicted in block 68 and illustrated in FIG. 2. An infeed conveyor belt 76 may place the cheese 74 on the lower belt 24 as illustrated in FIG. 2. The process is not limited to use of the illustrated infeed conveyor belt 76, however, and contemplates use of various types of dispensing methods and devices. The pre-cooked cheese 74 is placed on the lower belt 24 at a thickness of approximately twice the distance separating the lower cooking surface 16 and the upper cooking surface 18.

The pre-cooked cheese 74 is moved through the grill 10 by the rotating belts 24,38. As the cheese 74 moves through the grill 10, it is forced between the lower belt 24 and the upper belt 38, as illustrated in FIG. 3. The cheese is between the belts 24,38 for approximately two to five minutes, which time is controlled by the rotational speed of the belts 24,38 as explained above.

In this cooking process, a substantial amount of the moisture content of the cheese 74 is removed so that the resulting cheese product 78 (FIG. 4) contains between seven and fourteen percent moisture. The low moisture content allows the cheese product 78 to be stored without refrigeration, and have a sufficient shelf life to be stored, for example, on the shelf of a grocery store or a convenience store. Furthermore, the cooking process removes a substantial amount of various cheese elements considered to be non-healthy. The cooking process, for example, will typically remove between ten and twenty percent of fat from the cheese 74; between fifteen and thirty-one percent of the cholesterol from the cheese 74; between eight and eighteen percent of calories from the cheese 74; and between ten and twenty percent of the calories from fat from the cheese 74.

While the overall weight of the cheese 74 is decreased as the cheese is cooked and a portion of the fat and other components are removed, the amount of calcium and protein—elements with favorable health effects—in the cheese remains the same. Thus, the percentage of calcium and protein by weight is higher in the resulting cheese product than in the pre-cooked cheese. The resulting cheese product 78, therefore, is not only low in fats, cholesterol, and carbohydrates, but is rich in calcium and protein.

When the resulting cheese product 78 emerges from the grill 10 at the second end 22, the cheese product 78 is allowed to cool for between three and ten seconds, as depicted in block 70. This cooling period may occur while the cheese product 78 is being transported away from the grill 10 on an outfeed conveyor belt 80 illustrated in FIG. 4.

After the cooling period, the resulting cheese product is die-cut into pieces to be packaged and delivered, as depicted in block 72. The resulting cheese product 78 has a number of uses. The cheese product 78, for example, may be broken into small snack pieces resembling snack crackers or potato chips. The resulting cheese product may also be made into pizza crusts by cutting it into larger, circular pieces. When the cheese product 78 is cut into pizza crusts, the pieces of product 78 that remain after one or more circular crusts have been cut may be broken into small snack pieces. The cheese product 78 may also be made into food wraps to be used as a tortilla or crepe. To make the different products various settings may be altered. The distance between the lower cooking surface 16 and the upper cooking surface 18 would be less when making a crepe, for example, than when making a pizza crust. This list of items that may be produced via the above-described process is exemplary in nature and is not intended to be limiting in any way. A number of different products may be produced via the process by altering any of the settings.

An exemplary process by which pre-cooked cheese is prepared for the above-described process will now be described. The cheese is prepared from milk that includes 3.5-3.665% butterfat; 2.99-3.0973% protein; and 5.653-5.69% other solids. The milk is first tested for antibiotics, placed into a storage tank, and pasteurized in a process that involves heating the milk to a temperature of 165 degrees Fahrenheit. The pasteurized milk is then transferred it to a starter vat where it is allowed to cool. When the milk has cooled to a temperature of 90 degrees Fahrenheit, culture is added to the milk and is allowed to work for thirty to thirty-five minutes.

Rennet is added at the rate of 1.5 ounces per thousand pounds of milk. The rennet is stirred up and back, at which time all movement ceases. The milk is then allowed to stand until it forms a slit, then it is cut into small curds (coagulated milk) and allowed to heal for ten minutes. The sides are rubbed down and the curd is cooked until the temperature reaches 100 degrees Fahrenheit. The curd is allowed to stand for 10 to 15 minutes, and then is transferred to a finishing table. The table is drained until the whey (the watery part of milk that separates from the curd) only slightly covers the curd.

Cold water (65 degrees Fahrenheit or colder) or ice is added to cool the curd to 84 degrees Fahrenheit, at which point the whey is drained from the mixture. At this point the acidity should ideally be between 15 and 17, and should not exceed 21. Salt is added at the rate of 2.5 pounds per 1000 pounds of curd and is thoroughly distributed. The curd is placed in 40 pound Wilson hoops and placed in a press where additional whey is pressed out and the curd is knit into a solid, workable block of cheese.

Although the invention has been described with reference to the preferred embodiments illustrated in the attached drawings, it is noted that equivalents may be employed and substitutions made herein without departing from the scope of the invention as recited in the claims. It will be appreciated, for example, that one or more of the steps illustrated in FIG. 5 may be performed out of the order illustrated.

Having thus described the preferred embodiment of the invention, what is claimed as new and desired to be protected by Letters Patent includes the following:

1. A method of manufacturing a low-carbohydrate food product comprising the steps of:
(a) placing a quantity of cheese between a first surface and a second surface so that the cheese is in contact with at least one of the surfaces;
(b) heating at least one of the surfaces to cook the cheese; and
(c) causing at least one of the surfaces to move so that the cheese is moved from a first location to a second location while it is being cooked.

2. The method as set forth in claim 1, further comprising the step of:
(d) preparing the cheese by reducing the cheese to pieces.

3. The method as set forth in claim 2, step (d) further comprising the step of pulverizing the cheese.

4. The method as set forth in claim 1, further comprising the step of:
(e) allowing the cheese to cool for between three and ten seconds after being cooked and cutting the cooled cheese into pieces for packaging.

5. The method as set forth in claim 4, step (e) further comprising the step of cutting the cooled cheese into substantially round pieces for use as a pizza crust.

6. The method as set forth in claim 4, step (e) further comprising the step of cutting the cooled cheese into substantially bite-size pieces.

7. The method as set forth in claim 1, wherein step (b) further comprises the step of heating the first surface and the second surface so that both surfaces cook the cheese.

8. The method as set forth in claim 7, wherein step (b) further comprises the step of heating each of the surfaces to a temperature within the range 300 degrees Fahrenheit to 380 degrees Fahrenheit

9. The method as set forth in claim 7, wherein step (b) further comprises the step of heating the first surface and the second surface so that the first surface cooks the cheese at a different temperature than the second surface.

10. The method as set forth in claim 1, further comprising the step of:
(f) combining the cheese with an ingredient before the cheese is cooked to alter the resulting cooked cheese.

11. The method as set forth in claim 10, wherein step (f) further comprises the step of adding a fruit product to the cheese to enhance the flavor of the cheese.

12. The method as set forth in claim 10, wherein step (f) further comprises the step of adding a spice to the cheese to enhance the flavor of the cheese.

13. The method as set forth in claim 1, wherein step (a) further comprises the step of placing the cheese between the first surface and the second surface so that the cheese is in contact with both of the surfaces

14. The method as set forth in claim 1, wherein step (c) further comprises the step of causing both of the surfaces to move in the same direction at the same speed so that the cheese is moved from a first location to a second location while it is being cooked.

15. The method as set forth in claim 1, step (a) further comprising the step of mechanically placing the quantity of cheese between the first surface and the second surface.

16. The method as set forth in claim 1, step (a) further comprising the step of mechanically removing the cheese from between the first surface and the second surface.

17. A method of manufacturing a low-carbohydrate food product comprising the steps of:
(a) automatedly placing a quantity of cheese between a first surface and a second surface so that the cheese is in contact with both of the surfaces;
(b) heating both surfaces to a temperature within the range 300 degrees Fahrenheit to 380 degrees Fahrenheit to cook the cheese;
(c) causing both surfaces to move to transport the cheese from a first location to a second location while the cheese is being cooked;
(d) allowing the cheese to cool; and
(e) automatedly cutting the cheese into pieces for packaging.

18. The method as set forth in claim 17, further comprising the step of:
(h) combining the cheese with an ingredient before the cheese is cooked to alter the resulting cooked cheese.

19. The method as set forth in claim 17, wherein step (b) further comprises the step of heating the surfaces so that the first surface cooks the cheese at a different temperature than the second surface.

20. The method as set forth in claim 17, wherein step (c) further comprises the step of causing both surfaces to move at a speed such that the cheese cooks for between two and five minutes.

21. The method as set forth in claim 17, wherein step (a) further comprises the step of automatedly placing a quantity of cheese between a first surface and a second surface so that the cheese is in contact with both of the surfaces, wherein the cheese is all-natural and includes no preservatives.

22. A method of manufacturing a low-carbohydrate food product comprising the steps of:
(a) preparing a cheese by reducing the cheese to fine pieces;
(b) automatedly placing the pieces of cheese on a first end of a lower belt of a twin-belt grill, wherein the cheese is spread into a layer approximately three-eighths of an inch thick;
(c) placing an upper belt of the twin-belt grill so that a lower surface of the upper belt is spaced between one-fourth and one-half inch above an upper surface of the lower belt;
(d) heating a plurality of platens of the grill to transfer heat to the upper belt and to the lower belt of the grill, wherein the belts are heated to a temperature within the range 300 degrees Fahrenheit to 380 degrees Fahrenheit;
(e) rotating the belts to move the cheese between the belts toward a second end of the lower belt, wherein the cheese simultaneously contacts the lower belt and the upper belt for a period of between two and five minutes;
(f) automatedly removing the cheese product from the lower belt and allowing the cheese product to cool for between eight and ten seconds; and
(g) die-cutting the cooled cheese for distribution.

23. The method as set forth in claim 22, further comprising the step of:
(h) combining the cheese with an ingredient before the cheese is cooked to enhance the flavor of the cheese.

24. The method as set forth in claim 23, wherein step (h) includes the step of combining the pre-cooked cheese with a fruit product.

25. The method as set forth in claim 23, wherein step (h) includes the step of combining the pre-cooked cheese with a spice.
